(19) United States
(12) Patent Application Publication
(10) Pub. No.: US 2002/0065064 A1
(43) Pub. Date: May 30, 2002

(54) Methods and systems for reliable data delivery under mobile conditions

(75) Inventors: Thomas Griffith, Fairfax, VA (US); Stefan Van Rafelghem, Fairfax, VA (US); Stephen Russell, Fairfax, VA (US); Ronald Hirsch, Fairfax, VA (US)

Correspondence Address: OLIFF & BERRIDGE, PLC, P.O. BOX 19928, ALEXANDRIA, VA, 22320, US

(73) Assignee: AVTEC SYSTEMS, INC., Fairfax, VA (US)

(21) Appl. No.: 09/946,614

(22) Filed: Sep. 6, 2001

Related U.S. Application Data
(60) Provisional application No. 60/231,412, filed on Sep. 8, 2000.

(51) Int. Cl. H04M 11/00

(52) U.S. Cl. 455/405

(57) ABSTRACT

The present invention provides a first gateway that can receive, buffer and acknowledge a number of files from a data terminal. The gateway can then transmit one or more first segments derived from the received files to a wireless device over a first wireless link. In the event that the first wireless link is broken, any data not received by the wireless device by the first gateway can be provided to a second gateway. The second gateway, in turn, can provide the remaining data to the wireless device using one or more second segments without requiring that the second gateway contact the data terminal.

This non-provisional application claims the benefit of U.S. Patent Provisional Application No. 60/231,412 entitled “Security Mechanisms to Avert Threats in Wireless Network Operations” filed on Sep. 8, 2000 (Attorney Docket No. 105603). The Applicants of the provisional application are Ronald HIRSCH, Stefan Van RAFELGHEM, Thomas GRIFFITH and Stephen RUSSELL. The above provisional application is hereby incorporated by reference in its entirety including all references cited therein.

### BACKGROUND OF THE INVENTION

1. Field of Invention

This invention relates to methods and systems for managing communications and networks having wired and wireless portions.

2. Description of Related Art

As global telecommunications networks expand, the need to efficiently interface wired networked systems, such as the Internet, to wireless devices, such as an Internet-ready cellular phone, increases commensurately. However, maintaining a simple wireless communication link with a mobile device can be difficult. For example, if a pedestrian using a wireless phone moves from a first location serviced by a first cellular gateway to a second location serviced by a second cellular gateway, the first and second cellular gateways must establish separate wireless links to the wireless device and then “hand off” communication from the first gateway to the second gateway. Unfortunately, even the best “hand off” can result in some form a data loss. Furthermore, if the gateways and wireless device communicate using transmission control protocol (TCP) connections, a change in a physical wireless link can disrupt the network TCP connection. Such a disruption can not only require the second gateway and wireless device to establish a new TCP connection, but also require the wireless device to reinitiate the entire data transfer. Accordingly, new apparatus and methods that can more effectively interface wired and wireless systems are needed.

### SUMMARY OF THE INVENTION

The present invention provides methods and systems for improving data transmission across wired/wireless hybrid networks. In various embodiments, a technique is described for transferring data over a wired network to a first wired/wireless network gateway, which can forward the data to a wireless device.

In operation, the first gateway can receive, buffer and acknowledge a number of files using transmission control protocol (TCP). The gateway can then transmit one or more first segments derived from the received data to the wireless device over a first wireless link. In the event that the first wireless link is broken, any data not received by the wireless device from the first gateway can be provided to a second gateway. The second gateway, in turn, can provide the remaining data to the wireless device using one or more second segments.

By having the first gateway buffer receive data and then monitor the transfer of the received data as it is passed to the wireless device, any communication interruption over the first wireless link will not require the wireless device to reestablish a new TCP connection and reinitiate a new data transfer.

Additionally, the present invention provides a technique for transferring data from a wireless device to one or more network gateways and subsequently over a wired network.

In operation, the wireless device can transmit data to a first gateway via a first wireless link. The first gateway can receive, buffer and acknowledge one or more first segments of the received data, and subsequently transmit the data over a wired network. In the event that the first wireless link is broken, any data not received by the first gateway by the wireless device can be received by a second gateway via a second wireless link. The second gateway can receive the remaining data and subsequently transmit the data over a wired network. Accordingly, the data transmission of the wireless device can be seamlessly transmitted across the wired network.

Other features and advantages of the present invention are described below and are apparent from the accompanying drawings and from the detailed description which follows.

### BRIEF DESCRIPTION OF THE DRAWINGS

The invention is described in detail with regard to the following Figures, wherein like numerals reference like elements, and wherein:

FIG. 1 is a block diagram of an exemplary wired/wireless data network in accordance with the present invention;

FIG. 2 is a block diagram of a portion of the data network of FIG. 1 used with a mobile wireless device;

FIG. 3 is a block diagram of a second exemplary embodiment of the network portion of FIG. 2;

FIG. 4 depicts an exemplary satellite-based network portion;

FIG. 5 is a block diagram of the exemplary gateway of FIG. 1;

FIGS. 6A and 6B depict a flowchart outlining an exemplary operation for managing communications in a wired/wireless hybrid system; and

FIG. 7 is a flowchart outlining another exemplary operation for managing communication in a wired/wireless hybrid system.

### DETAILED DESCRIPTION OF PREFERRED EMBODIMENTS

This application incorporates the disclosure of Application No. ______ entitled “Methods and Systems for Interfacing Wired/Wireless Hybrid Systems” to Thomas Griffith et al. filed Jun. 19, 2001 (Attorney Docket No. 108342) herein incorporated by reference in its entirety.

With the advent of personal digital assistants (PDAs), Internet enabled cell phones and wireless computers, existing wireless networks are found to have many shortcomings. A particularly challenging issue is the problem of maintaining an ongoing communication session with a mobile device as the mobile device moves between various locations serviced by different gateways and access points. This problem is aggravated when a mobile device uses the transmission control protocol/Internet protocol (TCP/IP) communication suite.

Although the TCP portion of the TCP/IP communication suite can provide reliable data delivery for applications such as file transfers, remote logins and web browsing, TCP can be vulnerable in environments having a high latency and/or high-error rates. For example, a transmission device using TCP must first package any requested data in sequentially numbered data segments to assure that all of the data arrives. As the various segments are transmitted and received by a receiving device, the receiving device must extract the data from the sequentially numbered segments, reorder the data according to the sequential numbering scheme and then forward the data to a receiving party.

If the receiving device fails to receive one or more segments, and cannot complete the sequential ordering, the receiving device can store the successfully received segments in a cache memory for as long as the TCP connections exist. When the receiving device finally receives the missing segments, the receiving device can add the previously missing segments to the stored segments, sequentially order the data and forward the data to the receiving party.

However, if the physical link connecting the transmitting and receiving devices is severed or degraded to the point that all the segments are not received in a timely fashion, a “time-out” can occur. Such a time-out can require the transmitting and receiving devices to reestablish a new TCP connection and retransmit the entirety of the failed data of the original transfer.

The problem of high-latency physical links is especially evident in wired/wireless hybrid networks, where the relatively low reliability of a wireless link can virtually bring TCP communication to a halt. Furthermore, when data must be delivered to a mobile wireless device, the likelihood that a communication session will be interrupted increases dramatically. For example, if a pedestrian using a wireless phone moves from a first location serviced by a first cellular gateway to a second location serviced by a second cellular gateway, the first and second cellular gateways must establish separate wireless links and then “hand off” communication from the first wireless link to the second wireless link.

Unfortunately, even the best “hand off” can result in some form a data loss. Furthermore, if the wireless device is communicating using transmission control protocol (TCP), the change in wireless links can disrupt the TCP connection. Such a disruption can not only require the wireless device to establish a new TCP connection, but also require the wireless device to reinitiate the entire data transfer.

However, by allowing the first gateway to receive, buffer and acknowledge any data destined to the wireless device in a first session and then establish and monitor a wireless session between the first gateway and the wireless device, any interrupted communication between the first gateway and the wireless device can be gracefully resumed without requiring the first gateway to establish a new TCP connection with the data source of the first session, again request and receive the same data and attempt to forward the data to the wireless device.

Furthermore, if a second gateway is required to reestablish a wireless link to the wireless device, the first gateway can provide the second gateway with the received data and other information necessary to complete the wireless session. The second gateway, in turn, can complete the data transfer without requiring the second gateway to establish a new TCP connection, request and receive the same data from the data source and forward the data to the wireless device.

This approach to buffering and forwarding data can not only speed up the transfer of information, but it can also relieve the overall communication load on the wired portion of the communication network.

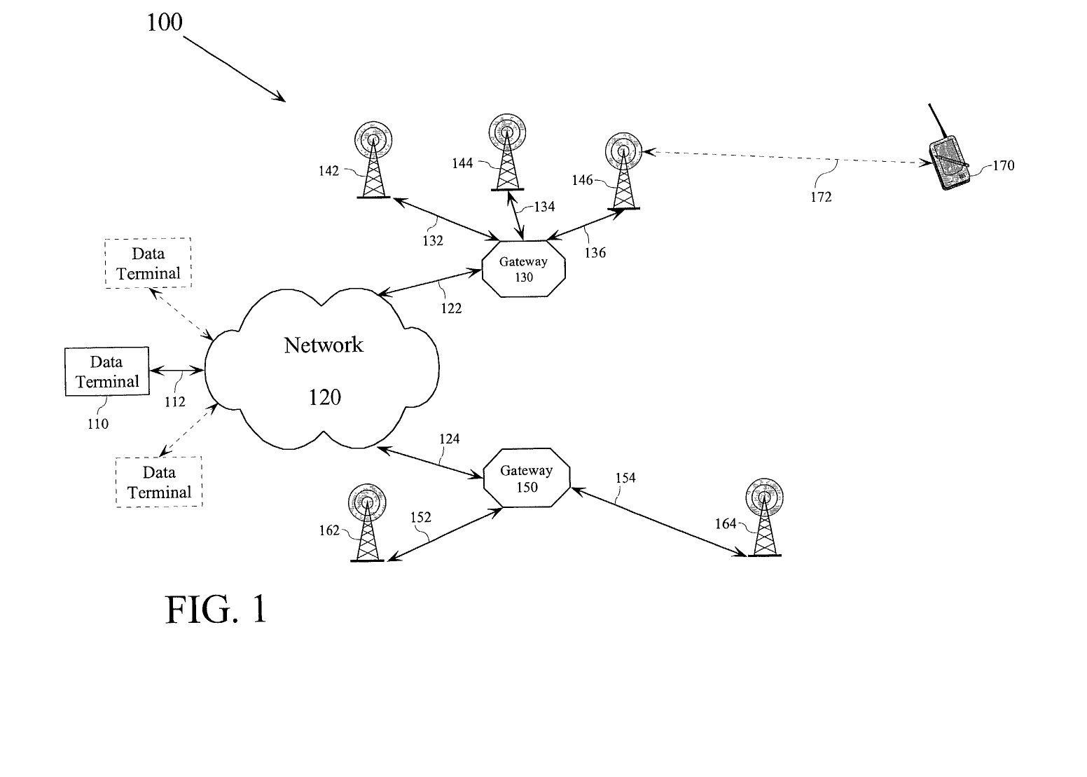

FIG. 1 is a block diagram of an exemplary communication system 100 having both a wired and wireless portions. The communication system 100 includes a network 120 coupled to a data terminal 110, and further coupled to a number of gateways 130 and 150. The gateways 130 and 150, in turn, are coupled to a first and second group of access points 142-146 and 162-164 respectively. Furthermore, each of the access points 142-146 and 162-164 can communicate with one or more wireless device(s), such as a wireless personal digital assistant(s) (PDA) 170, via a wireless link 172.

In operation, the data terminal 110 can transmit data to and receive data from the network 120 over link 112. The network 120, in turn, can transmit data to and receive data from the gateways 130 and 150 via links 122 and 124 respectively. As TCP segments are transmitted from the data terminal 110 to the various gateways 130 and 150, the gateways 130 and 150 can forward the information contained in the received TCP segments to various wireless devices using one of the available gateways 142-146 and 162-164. Similarly, the wireless PDA 170 can provide various segments to one of the access points 142-146 and 162-164, which then can provide the received information to the data terminal 110 via the network 120.

The exemplary data terminal 110 can be a personal computer executing transmission control protocol (TCP) operating over Internet protocol (IP), commonly referred to as TCP/IP. However, the data terminal 110 can also be any one of a number of different types of data sources, such as a computer, a storage device, or any combination of software or hardware capable of generating, relaying, or recalling from storage data capable of being transmitted, directly or indirectly, to a transmission network, or medium, using a network protocol without departing from the spirit and scope of the present invention.

The exemplary network 120 can be a portion of the Internet. However, the network 120 can also be a wide area network or a local area network, and intranet, any subset of the Internet, or any distributed processing network or system. In general, the network 120 can be any known or later developed combination of transmission mediums, computer programs, or structures usable to transmit data between the data source 110 and the gateways 130 and 150 without departing from the spirit and scope of the present invention.

Accordingly, data links 112, 122 and 124 can be links with the Internet. However, data links 112, 122 and 124 can also be links in a wide area network or a local area network, an intranet, any subset of the Internet, or links on any distributed processing network or system. In general, data links 112, 122 and 124 can be any known or later developed transmission medium, computer program, or structure usable to transmit data between the network 120 and the data terminal 110 and gateways 130 and 150 without departing from the spirit and scope of the present invention.

The gateways 130 and 150 can be computer based servers with specialized interfaces capable of interfacing the Internet with a wireless network having a different protocol. However, it should be appreciated that a “gateway” can be any known or later developed combination of systems and devices capable of interfacing a wired network, such as the Internet, with a wireless network, such as a cellular or satellite based network, without departing from the spirit and scope of the present invention.

While the exemplary data terminal 110, network 120 and gateways 130 and 150 can communication using TCP, the various devices 110, 120, 130 and 150 can, in other exemplary embodiments, communicate using other existing communication protocols. Furthermore, because protocols can evolve over time or be replaced in part or in whole, it should be appreciated that the various devices 110, 120, 130, and 150 can communicate using any known or later developed protocol such as Ethernet, 10baseT, UDP or variants thereof, without departing from the spirit and scope of the present invention.

Each of the exemplary access points 142-146 and 162-164 is a wireless transmitter/receiver capable of transmitting and receiving various radio signals according to a CDMA-based or TDMA or GSM or any other future transmission protocols. However, the various access points 142-146 and 162-164 alternatively can be any number of different devices, such as a radio frequency or microwave wireless transmitter/receiver, a transmission/reception system employing wires such as a twisted wire pair, a transmitter/receiver adapted for transmitting across coaxial cable, an optical transmitter/receiver, a fiber/optic transmitter/receiver, a sonic transmitter/receiver, satellite dish, wireless LAN, such as 802.11, or any other known or later developed device suitable for transmitting/receiving data. Accordingly, a wireless device, such as the wireless PDA 170, can be any number of devices capable of communicating with any of the access points 142-146 and 162-164 including specially adapted computer based systems, cellular phones, Internet enabled cell phones, PDAs, two-way pagers, or any other known or later developed device.

Returning to FIG. 1, the data terminal 110 and the PDA 170 can communicate in exchanges of information known as “sessions”. Generally, a “session” can be a transfer of data between two devices preceded by a connection request and subsequently acknowledged. The exemplary sessions transfer data by packaging the data into various segments and transmitting the data segments from one device to another. Accordingly, in various exemplary embodiments, the term “segment” can include any form of packaged information containing a finite amount of data, e.g., a packet, according to any known or later developed protocol useful for transporting information.

In the exemplary communication system 100, a communication between the data terminal 110 and the wireless PDA 170 can be divided into two separate sessions. For example, the wireless PDA 170 can request a web page from the data terminal 110. In response, the data terminal 110 can provide the various associated web page files to the first gateway 130 in a first session. The gateway 130 can acknowledge receipt of the various files, store the files and initiate a second session with the wireless PDA. During the second session, the gateway 130 can repackage the web page files in various second segments and provide the second segments to the wireless PDA 170 using access point 146.

As the wireless PDA 170 communicates with the data terminal 110, it should be appreciated that the wireless device 170 will typically use the most accessible gateway and access point. For example, as shown in FIG. 1, the wireless PDA 170 can communicate with the data terminal 110 using gateway 130 and access point 146, which are depicted as the best gateway and access point.

The best gateway and access point can be determined by any well known method. As an example, the signal-to-noise-ratio (SNR) of a received signal can be used to determine the primary access point. A primary access point, once designated, shall remain the primary access point until its SNR (for the PDA) is exceeded by a SNR of a second access point. Additionally, other characteristics, such as bit error rate (BER), proximity and multi-path environment can be used to determine a primary access point.

The selection of the access points can be a dynamic selection wherein all access points continually measure the SNR or other characteristics from the wireless PDA. This measurement is sent to the wireless PDA. When the characteristic of the primary access point falls below the characteristics of a secondary access point, then the secondary access point is designated as the primary, and the old access point is designated as a secondary access point. This refreshing of the access point will automatically and seamlessly route data to the wireless PDA though the new access point.

However, because wireless devices can be mobile, it should be appreciated that the position of the wireless PDA 170 can change in a manner such that it can no longer readily communicate with gateway 130 and/or access point 146. For example, a pedestrian (not shown) carrying the wireless PDA 170 can enter a subway station that can effectively shield wireless transmissions between the wireless PDA 170 and the access point 146. The pedestrian can later exit the subway station or likely exit from another subway station.

If the pedestrian exits from the same subway station, the wireless PDA 170 can resume communicating with gateway 130, i.e., resume the original wireless session. However, if the pedestrian exits from a subway station sufficiently distant from access point 146, the wireless PDA 170 may need to access another access point and/or another gateway to complete the wireless session.

As discussed above, a communication between the wireless PDA 170 and the data terminal can be divided into two separate sessions with the first session between gateway 130 and the data terminal 110 and the second session occurring between the gateway 130 and the wireless PDA 170. During operation, as gateway 130 has reconstructed any files received from the data terminal 110, the gateway 130 can initiate the second (wireless) communication session by first packaging the stored files into various numbered segments, and providing the segments to the wireless PDA 170.

Also as discussed above, it should be appreciated that the various segments packaged by the gateway 130 can be numbered such that the data contained in the segments can be appropriately ordered by the wireless PDA 170 to again reconstruct the session files even if the segments are not received in the correct serial order. For example, the gateway 130 can divide a file containing ten-thousand bits into five segments containing two-thousand bits each. Each of the segments can be numbered one through five such that segment one will contain the first two-thousand bits, segment two can contain the second two-thousand bits and so on. Regardless of the order that the various segments are received by the wireless PDA 170, the wireless PDA 170 can successfully reorder the information using the sequential numbering scheme within the received segments to reconstruct the original ten-thousand bit file.

As each of the constituent segments are transmitted to the wireless PDA 170, the wireless PDA 170 can acknowledge the successful receipt of each segment. Unsuccessfully received/acknowledged segments can be retransmitted until all of the segments are successfully received/acknowledged by the wireless PDA 170.

During transmission, gateway 130 can monitor the progress of a communication session and store an indicator that each segment transmitted by gateway 130 was successfully received/acknowledged by the wireless PDA 170 in a specially created session log. If a particular session between the gateway 130 and wireless PDA 170 is interrupted, gateway 130 can suspend the wireless session and store the relevant session files, including the session log, for a predetermined time or until the wireless PDA 170 comes in contact with access point 146 or one of the other access points.

If the wireless PDA 170 reestablishes contact with any of the access points 142146 servicing gateway 130, the gateway 130 can retrieve the stored session files, and resume the wireless session or establish a second wireless session with the wireless PDA 170. In various exemplary embodiments, the gateway 130 can then send only those segments or data not previously received and acknowledged by the wireless PDA 170. However, in various other embodiments, it should be appreciated that the gateway 130 can retransmit all of the data from the first wireless session or any other subset of the session data.

However, if the wireless PDA 170 establishes contact with an access point servicing a second gateway, it should be appreciated that the gateway 130 can transfer the stored session files to the second gateway servicing the wireless PDA 170 to enable the second gateway to complete the wireless session.

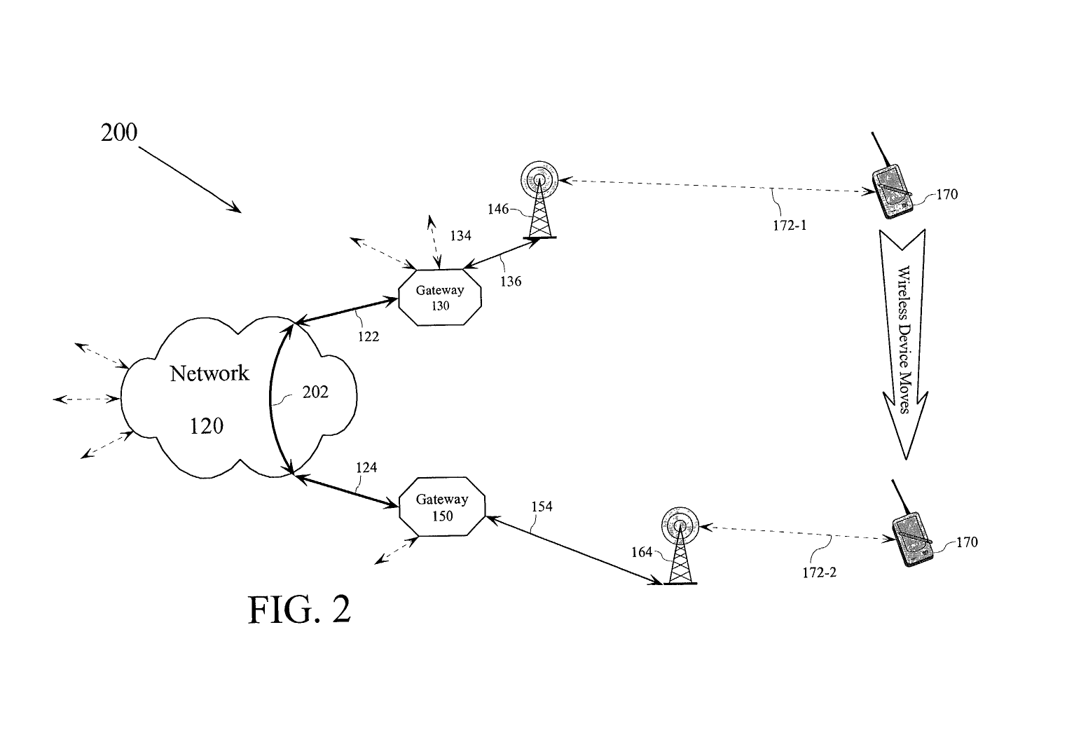

FIG. 2 is an exemplary network portion 200 of the communication system 100 of FIG. 1. As shown in FIG. 2, the wireless PDA 170 has a first establish wireless link 172-1 and, after the wireless PDA 170 relocates to second location serviced by access point 164, the wireless PDA 170 can establish a second wireless link 172-2 to access point 164.

Assuming that the wireless PDA 170 breaks contact with access point 146 in the middle of a wireless session, it should be appreciated that the wireless PDA 170 may still desire to complete the interrupted session. Accordingly, after the wireless PDA 170 establishes the wireless link 172-2 with access point 164, the second gateway 150 can retrieve the various session files of the incomplete wireless session of the first gateway 130.

To complete the wireless session, the gateway 150 must determine that an earlier wireless session was not completed. In various embodiments, an indication can be received from the wireless PDA 170 in the form of a special message. For example, after connecting with access point 164, the wireless PDA 170 can send gateway 150 a signal indicating that a previous wireless session was incomplete as well as other pertinent information, such as an identification of the previously used gateway and access point, a special identification number relating to the session, the time and date of the interrupted wireless session and the like.

In other exemplary embodiments, the second gateway 150 can broadcast a query based on the identification number or Internet address of the wireless device to various other gateways and/or to a central server in the network 120 (not shown) that contains a database of all incompleted communication sessions for a predetermined time period.

Once the second gateway 150 has determined that a wireless session relating to the wireless PDA 170 is incomplete, the second gateway 150 can request the various session files, including the session log, from the first gateway 130. The exemplary gateways 130 and 150 of FIG. 2 can perform the various queries and provide file transfers using a network path 202 established by the network 120. Upon receiving the various session files, gateway 150 can determine which segments of information were not received by the wireless PDA 170 based on the session log and transmit the remaining segments or data to the wireless PDA 170 until the wireless PDA 170 receives all the pertinent information relating to the wireless session.

While the exemplary gateway 150 transmits only those segments that were not received and acknowledged in the first wireless session, it should be appreciated that the second gateway 150 can alternatively transfer the entire session, i.e., all segments of the wireless session whether received and acknowledged or not.

Further, it is to be understood that in a similar but reverse manner, the wireless device 170 can transmit data to one or more gateways during a data transmission. For example, if during a data transmission from the wireless PDA 170 to the gatekeeper 130, the wireless PDA 170 changes location such that the wireless PDA 170 needs to access another gateway to complete the wireless data transmission, then the gateway can seamlessly “hand-off” the wireless PDA 170 transmission in a similar manner to that described above. In other words, a first portion of the wireless data transmission from the PDA 170 is received by a first gateway, and a second portion of the wireless data transmission is received by a second gateway. Further, the first and second gateway can coordinate via network 120 so that the entire wireless data transmission is transmitted to data terminal 110 via the wired network.

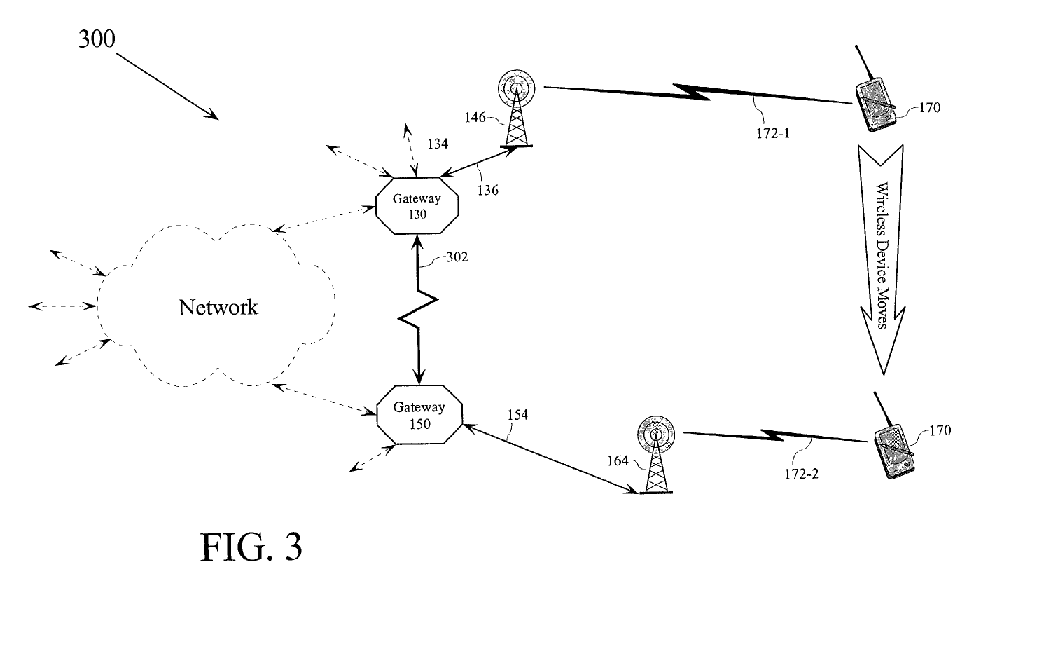

FIG. 3 is a modified network portion 300 of the communication system 100 of FIG. 1. As shown in FIG. 3, gateways 130 and 150 are connected by a gateway communication link 302. In operation, the gateways 130 and 150 can operate according to the communication scheme outlined above. However, the modified network portion 300, unlike the network portion of FIG. 2, can use the gateway communication link 302 for a number of purposes, such as performing session queries and passing session files.

The exemplary gateway communication link 302 can be an optical link that can transmit data between gateway 130, gateway 150 and any other gateways making up the infrastructure of the modified network portion 300. However, it should be appreciated that the gateway communication link 302 can alternatively be any known or later developed communication system such as a T1 link, an E1 link, a wireless microwave link and the like without departing from the spirit and scope of the present invention.

An advantage to using the gateway communication link 302 is that the gateway communication link 302 can accommodate much faster session queries and data transfers that can be accomplished by using non-dedicated links in a network such as the Internet.

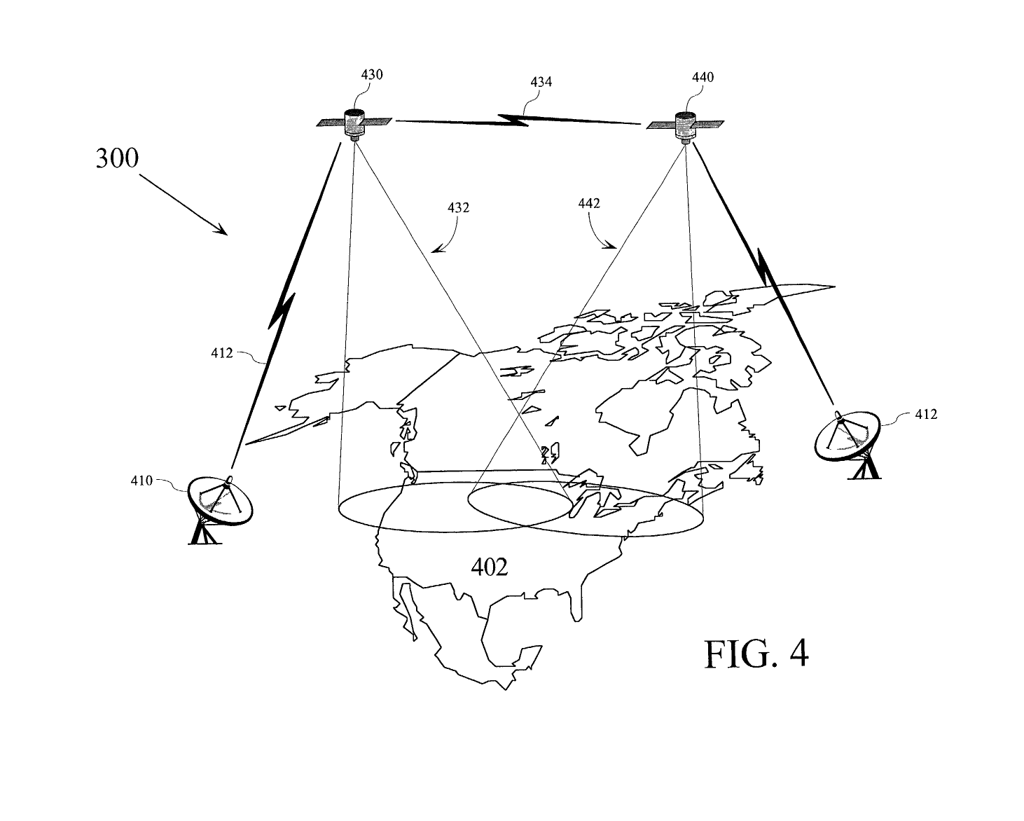

FIG. 4 is another wireless network portion 400 where the access points of FIG. 1 are replaced by an array of satellite dishes 410 and 420 and satellites 430 and 440. As shown in FIG. 4, the satellite dish 410 can receive information from and transmit data to the first satellite 430 via wireless link 412. The first satellite 430 accordingly can relay information to and from various wireless devices residing in a first zone 432 (shown against a background map 402). Similarly, satellite dish 420 can receive information from and transmit information to satellite 440, which can relay information to and from a second zone 442.

The exemplary satellites 430 and 440 are part of an array of low earth orbit satellites with each satellite 430 and 440 capable of communicating with various mobile devices within their respective zones 432 and 442. However, the satellites 430 and 440 can alternatively be geosynchronous satellites, high-orbit satellites, deep space satellites, communication devices in vehicles such as airplanes and the like without departing from the spirit and scope of the present invention.

As a mobile wireless device is transported from the first zone 432 to the second zone 442, it should be appreciated that any ongoing session in the first zone 432 may be interrupted. Accordingly, such a mobile wireless device must establish contact with a gateway (not shown) serviced by satellite 440 and satellite dish 420. After contact is established, the gateway associated with satellite dish 420 can perform a query and subsequently retrieve any session files and session logs relating to the interrupted communication session from a first gateway (not shown) serviced by satellite 430 and satellite dish 410.

While the exemplary satellite system 400 can transfer data files from the first gateway to the second gateway using a ground-based wired network, it should be appreciated that, in various embodiments, the various satellites 430 and 440 can contain sufficient memory and processing power to receive and store a session from a data terminal and retransmit the data to the mobile device while monitoring session transfer. That is, the satellites 430 and 440 can take on some of the functionality of the gateways of FIGS. 1-3.

For example, satellite 430 can receive a session from a data terminal via satellite dish 410, store the session and relay the various files comprising the communication session to a mobile device within the first zone 432. However, if the mobile device leaves the first zone 432 and enters a second zone 442, the mobile device can make contact with the second satellite 440. Accordingly, satellite 440 can query the first satellite 430 via a direct satellite-to-satellite link 434 and retrieve the appropriate session files. The query can be via a mutually visible ground station or gateway, as well as direct satellite-to-satellite link. In other words, the satellites may be viewed as the gateway. Once the session files are received, the second satellite 440 can transmit the remaining session segments or data to the mobile device as long as the mobile device remains in the second range 442.

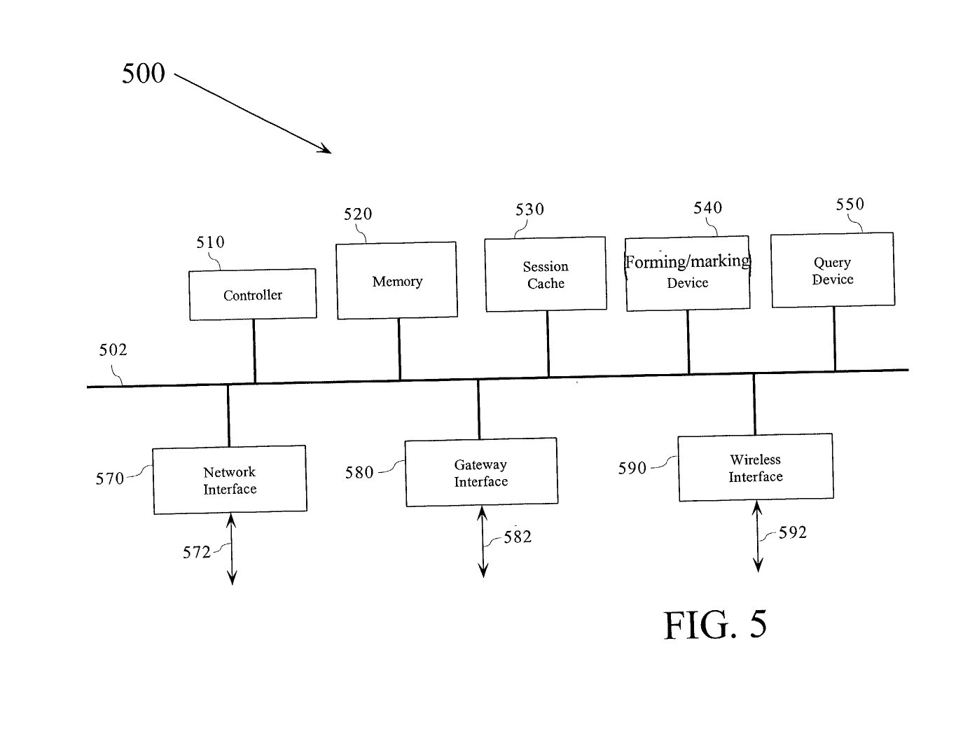

FIG. 5 is a block diagram of the exemplary gateway 500 of FIG. 1. The exemplary gateway 500 can include a controller 510, a memory 520, a session cache 530, a segment forming/marking device 540, a query device 550, a network interface 570, a gateway interface 580, and a wireless interface 590. The above components are coupled together by control/data bus 502. Although the exemplary gateway 500 uses a bussed architecture, it should be appreciated that any other architecture may be used as is well known to those of ordinary skill in the art.

In a first series of operations, and under control of the controller 510, the network interface 570 can receive a number of segments relating to a wired communication session via link 572, acknowledge receipt back to the source via link 572 and provide the various segments to memory 520. As discussed above, a communication session can refer to the transfer of any number of data files and other information that can be transmitted using any number of segments.

After the gateway 500 receives the segments of the wired communication session, the controller 510 can extract the data from the various segments, reconstruct the files constituting the wired communication session and store the reconstructed files in memory 520.

Next, the reconstructed files can be provided to the segment forming/marking device 540. The segment forming/marking device can then create a number of new segments suitable for transmission across a wireless link, such as a cellular or satellite based link. After the segment forming/marking device 540 creates the various wireless segments, the segment forming/marking device 540 can then mark the various segments with a series of numbers such that a device receiving the various segments can order the segments using the numbers and again reconstruct the files appropriately.

Once the wireless segments are formed and appropriately numbered, the segment forming/marking device 540 can provide the segments to a wireless device, such as a PDA with a wireless interface, via the wireless interface 590 and link 592. As each wireless segment is transmitted, the receiving wireless device can provide an acknowledgment signal indicating whether each wireless segment was successfully received. If a wireless segment remains unacknowledged or the wireless device returns a signal indicating that a received segment is corrupted, the segment forming/marking device 540 can retransmit the corrupted segment until the segment is successfully received.

As each segment of the wireless communication session is transmitted and appropriately acknowledged, the session cache 530 can update a record in a specially created session log, thus tracking the status of each wireless segment. In the case where a wireless communication session is interrupted, the session cache 530 can update the session log, store the various files and other information associated with the wireless session, such as the original files from the wired session, the various unsuccessfully received wireless segments formed by the segment forming/marking device 540, the time and date that the wireless session was interrupted and a special identification number or URL associated with the wireless device.

If the wireless device reestablishes contact with gateway 500, the gateway 500 can complete the wireless session by recalling the various unsuccessfully transmitted segments from the session cache 530 and transmitting the various remaining segments to the wireless device via the wireless interface 590 and link 592.

However, as discussed above, a wireless device can from time to time establish contact with a second gateway. Accordingly, in a second series of operations, and under control of the controller 510, the gateway 500 can receive an information request from the second gateway via the network interface 570 or the gateway interface 580, which can be connected to a number of other gateways.

Once the information request is received, the controller 510 can search the session cache 530 for any information pertaining to the information request. If the controller 510 finds no sessions relevant to the information request, the controller 510 can respond appropriately. However, if the controller 510 finds an unfinished session in the sessions cache 530 relating to the information request, the controller 510 can recall the unfinished session files, including the session log, and provide the session files to the second gateway.

Similarly, in a third series of operations, if the gateway 500 establishes contact with a wireless device, the gateway 500 can first determine whether the wireless device should complete an unfinished session. The exemplary gateway 500 can determine whether the wireless device has an unfinished session by receiving a signal from the wireless device, which can include an identification number of the wireless device and/or indicators as to whether the wireless device is processing an unfinished session, and provide the identification number and/or indicators to the query device 550.

The query device 550 can receive the wireless device identification number and/or indicators, form an information request based on the identification number and/or indicators and send the information request to the appropriate gateway. While the exemplary query device 550 can determine the appropriate gateway to query based on information provided by the wireless device, it should be appreciated that in other exemplary embodiments, that the query device 550 can alternatively broadcast a general purpose information request to any number of other gateways.

If any gateway responds with an indicator that it has an unfinished session relating to the wireless device, the query device 550 can request the gateway to provide the unfinished session files. The gateway 500 can then receive the unfinished session files via the network interface 570 or gateway interface 580 and store the session files in the segment forming/marking device 540 and further store the session log in the session cache 530.

Once received, the segment forming/marking device 540 can provide the previously unsuccessfully received segments to the wireless device via the wireless interface 590 and link 592. As each segment is successfully received and acknowledged, the session cache 530 can update the received session log until the communication session is successfully completed or the communication session is again interrupted.

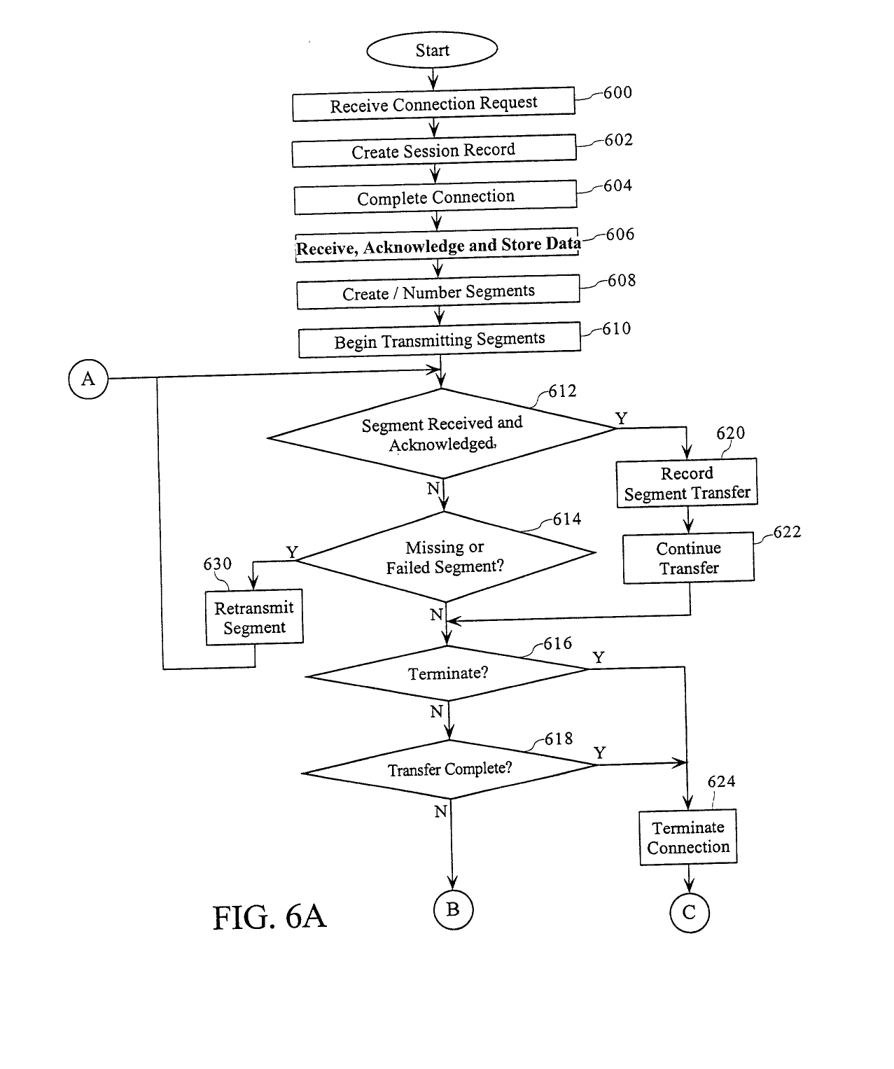

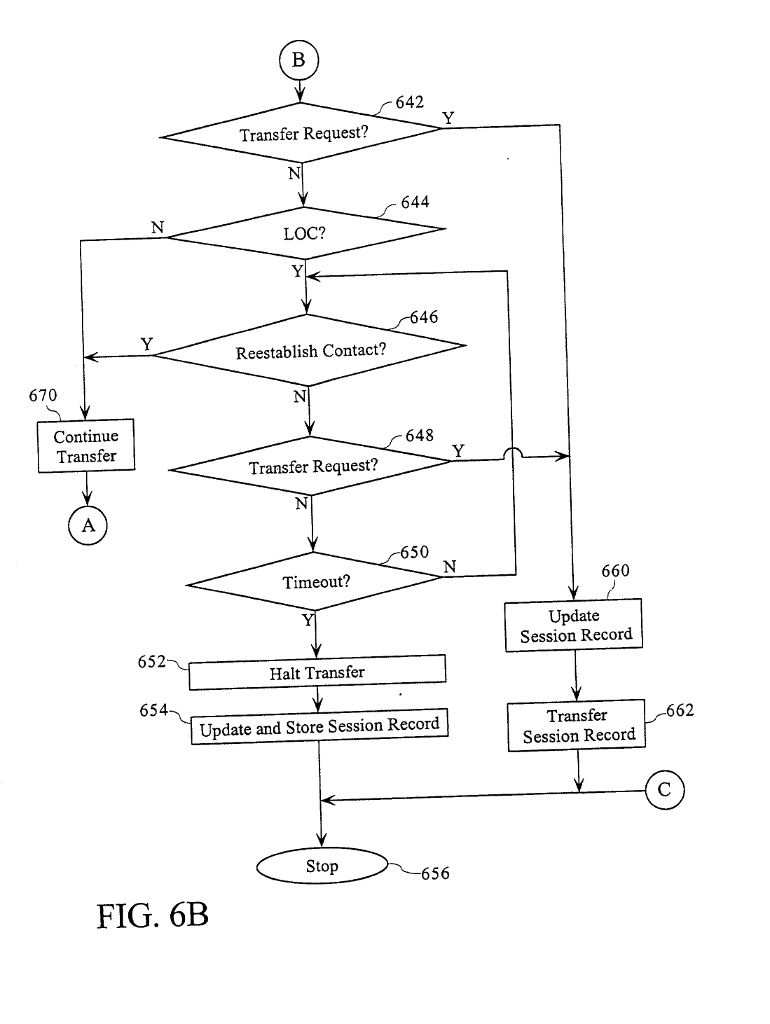

FIGS. 6A and 6B depict a flowchart outlining a first operation for communicating over a wired/wireless hybrid communication system. The operation starts in step 600 where a connection request is received by a gateway from either a wireless device, which can be forwarded to a wired terminal, or a wired terminal, which can be forwarded to the wireless device. Next, in step 602, a session log is created. As discussed above, a session log can contain a variety of information relevant to a wireless communication session including identification numbers of the wired terminal and wireless device, the Internet addresses (URLs) of the wired terminal and wireless device and the like. Control continues to step 604.

In step 604, a connection, such as a TCP connection, is established between the wireless device and wired terminal. Next, in step 606, the gateway can receive, acknowledge and store data from a first, wired session with the wired terminal. As discussed above, once the gateway receives the various segments from the wired terminal, the gateway can reconstruct any and all files that constitute the wireless communication session. Then, in step 608, a number of segments suitable for transmission across a wireless link are formed from the reconstructed files and appropriately numbered to preserve the order of the data. Control continues to step 610.

In step 610, the various segments created and numbered in step 608 are transmitted from the gateway to the wireless device. Next, in step 612 a determination is made as to whether a particular segment transmitted in step 610 is received and acknowledged. If the segment is received and acknowledged, control jumps to step 620; otherwise, control continues to step 614.

In step 614, another determination is made as to whether a particular segment is missing, i.e., not acknowledged, or acknowledged as a failed segment. If the particular segment is missing or acknowledged as failed, control jumps to 630; otherwise, control continues to step 616.

In step 630, the particular segment determined as missing or failed at step 614 is retransmitted and control jumps back to step 612 where the remaining segments can be further received and acknowledged.

In step 620, because a particular segment was received and appropriately acknowledged, the session log is updated to indicate that the segment was successfully transferred. Next, in step 622, the wireless communication session continues as the remaining segments are transferred. Control then continues to step 616.

In step 616, a determination is made as to whether to terminate the ongoing wireless communication session. If the session is to be terminated, control jumps to 624; otherwise, control continues to step 618.

In step 618, a determination is made as to whether the ongoing wireless communication session is complete, i.e., whether all of the segments formed in step 608 are successfully received and appropriately acknowledged. If the transfer is complete, control jumps to step 624; otherwise, control continues to step 642.

In step 624, the ongoing wireless communication session is terminated and control jumps to step 656 where the process stops.

Otherwise, in step 642, a determination is made as to whether a transfer request is received, i.e., a request by a distant device, such as a gateway, indicating that the distant device will complete the session. As discussed above, a transfer request can occur as a mobile wireless device moves from a first communication zone to a second communication zone, and a decision is taken to allow the gateway servicing the second communication zone to continue the wireless communication session. If a transfer request is received, control jumps to step 660; otherwise, control continues to step 644.

In step 644, a determination is made as to whether there is a loss of contact between the wireless device and the gateway presently handling the wireless communication session. If a loss of contact has occurred, control continues to step 646; otherwise, control jumps to 670.

In step 646, a determination is made as to whether contact has been reestablished between the wireless device and the gateway. If contact is reestablished, control jumps to 670; otherwise, control continues to step 648.

In step 670, because there has been no loss of contact or because contact has been reestablished, the transfer of segments from the gateway to the wireless device continues and control jumps back to 612 where more segments can be received and acknowledged.

Otherwise, in step 648, another determination for a transfer request is made. If a transfer request has been made, control jumps to step 660; otherwise, control continues to step 650.

In step 650, a determination is made as to whether a time-out has occurred, i.e., whether an excessive amount of time has lapsed since the loss of contact determined at step 644. If a time-out has occurred, control continues to step 652; otherwise, control jumps back to step 646 where another determination is made whether contact has been reestablished.

In step 652, the wireless communication session is halted, i.e., the transfer of segments is stopped. Next, in step 654, the session log is updated to reflect the state of the wireless communication session and the session log is stored. Control then continues to step 656 where the process stops.

In step 660, because a transfer request has occurred, the session log is updated to reflect the state of the session, i.e., whether each segment is successfully received and acknowledged. Next, in step 662, the session record along with the rest of the session data is transferred to the new gateway handling the wireless communication session and control continues to step 656 where the process stops.

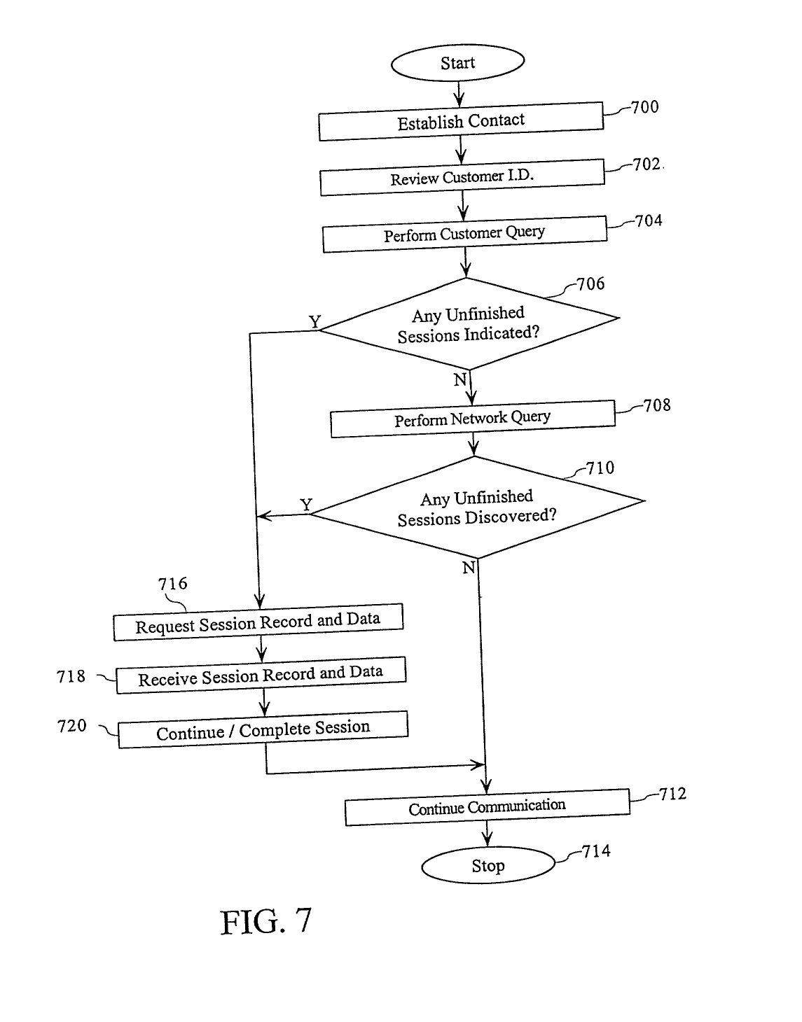

FIG. 7 is another flowchart outlining an exemplary operation for communicating between a gateway and a wireless device, such as a wireless PDA. The operation starts in step 700 where contact between a gateway and a wireless device is established. Next, in step 702, the gateway can receive and review the customer identification number and/or the Internet address of the wireless device. Then, in step 704, the gateway can perform a query from the wireless device to determine whether the wireless device wishes to continue in a previously unfinished wireless communication session. Control continues to step 706.

In step 706, a determination is made as to whether the wireless device has indicated that it has an unfinished wireless communication session. If an unfinished wireless communication session is indicated, control jumps to step 716; otherwise, control continues to step 708.

In step 708, a network query is broadcast to other gateways to determine whether any other gateway has any information relating to any unfinished wireless communication sessions associated with the wireless device. Next, in step 710, a determination is made as to whether any unfinished wireless communication sessions have been discovered based on the query of step 708. If any unfinished wireless communication sessions are discovered, control jumps to step 716; otherwise, control continues to step 712.

In step 716, a request for the wireless communication session files is made to any gateway possessing an unfinished wireless communication session record. Next, in step 718, the session records and other related data is received. Then, in step 720, the wireless communication session is continued and completed. Control continues to step 712.

In step 712, further communications between the wireless device and gateway and/or another device such as a wire terminal can continue, i.e., another session can be initiated and completed. Control then continues to step 714 where the process stops.

As shown in FIG. 5, the methods of this invention are preferably implemented using a general purpose computer such as a personal computer with peripheral integrated circuit elements and dedicated communication hardware. However, the gateway 500 can be implemented using any combination of one or more programmed special purpose computers, programmed microprocessors or micro-controllers and peripheral integrated circuit elements, ASIC or other integrated circuits, digital signal processors, hardwired electronic or logic circuits such as discrete element circuits, programmable logic devices such as a PLD, PLA, FPGA or PAL, or the like. In general, any device capable of implementing a finite state machine that is in turn capable of implementing the flowchart shown in FIGS. 6 and 7 can be used to implement the gateway 500.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. Thus, there are changes that may be made without departing from the spirit and scope of the present invention.

What is claimed is:

1. A method for communicating, comprising:
receiving one or more files by a first gateway over a wired network;
transmitting one or more first segments using the first gateway, wherein the one or more first segments contain at least first data from the one or more files; and
transmitting one or more second segments using a second gateway, wherein the one or more second segments contain at least second data from the one or more files;
wherein the second data is provided to the second gateway by the first gateway.

2. The method of claim 1, wherein the one or more first segments are transmitted to a wireless device, and wherein the one or more second segments are transmitted to the wireless device.

3. The method of claim 2, further comprising updating a session log in response to at least one of the first segments being received by the wireless device.

4. The method of claim 2, wherein the second data is provided to the second gateway in response to a signal transmitted from the second gateway to the first gateway.

5. The method of claim 4, further comprising updating a session log in response to at least one of the first segments being received by the wireless device.

6. The method of claim 5, further comprising providing the session log to the second gateway.

7. A method for communicating over a wireless network, comprising:
receiving one or more first segments from a first gateway over a first wireless link; and
receiving one or more second segments from a second gateway over a second wireless link;
wherein the one or more second segments contain data provided to the first gateway over a wired network.

8. The method of claim 7, wherein the wireless device is a mobile wireless device.

9. The method of claim 8, wherein receiving the one or more second segments are received in response to the mobile wireless device being moved to a location serviced by the second gateway.

10. The method of claim 9, wherein the one or more second segments are transmitted using a session log provided by the first gateway.

11. A gateway for communicating over a wired/wireless hybrid network, comprising:
a receiver that receives one or more files over a wired network portion;
a transmitter that transmits one or more first segments to a wireless device over a first wireless link, wherein the one or more first segments contain first data from the one or more files;
a second transmitter that provides at least second data from the one or more files to a second gateway, wherein the second data is provided to the wireless device by the second gateway over a second wireless link.

12. The gateway of claim 11, further comprising a session cache that contains a session log, wherein the session log is updated in response to at least one first segment being received by the wireless device.

13. The gateway of claim 12, wherein the second data is provided to the wireless device using the session log.

14. A communication system, comprising:
a first gateway that receives one or more files containing first data and second data over a wired network, wherein the first gateway provides at least the first data to a wireless device over a first wireless link; and
a second gateway that receives at least the second data from the first gateway and provides the second data to the wireless device over a second wireless link.

15. The communication system of claim 14, wherein the first gateway provides an acknowledgment signal to the source of the one or more files.

16. The communication system of claim 15, wherein the first gateway includes a session cache that contains a session log, wherein the session log is updated in response to at least one first segment being received by the wireless device.

17. The communication system of claim 16, wherein the session is provided to the second gateway in response to the wireless device being moved to a location serviced by the second gateway.

18. A method for communicating, comprising:
transmitting first data to a wireless device using a first gateway;
updating a session log based on at least the transmission of the first data;
providing the log to a second gateway, wherein the second gateway transmits second data to the wireless device based on the session log.

19. The method of claim 18, wherein the second data is provided to the second gateway by the first gateway.

20. The method of claim 19, further comprising receiving the first and second data by the first gateway.

21. The method of claim 20, wherein the session log is provided to the second gateway in response to a signal transmitted from the second gateway to the first gateway.

22. The method of claim 20, wherein updating the session log is further based on the successful reception of the first data by the wireless device.

23. A method for communicating, comprising:
receiving a first portion of a data transmission from a wireless device at a first gateway;
receiving a second portion of the data transmission from the wireless device at a second gateway; and
combining at least the first and second portions of the data transmission to generate the data transmission.

24. The method according to claim 23, further comprising transmitting the combined data transmission over a wired network.

25. The method according to claim 23, wherein the second gateway receives the second portion of the data transmission based on a session log provided by the first gateway.

26. The method according to claim 25, wherein the session log is provided from the first gateway to the second gateway via a wired network.

27. The method according to claim 1, wherein one or more second segments are transmitted using a second gateway when communication characteristics of the second gateway exceed communication characteristics of the first gateway.

28. The method according to claim 27, wherein the communication characteristics include at least one of a SNR and a BER.

29. The method according to claim 27, wherein the communication characteristic is based on a number of wireless devices currently connected with a gateway, wherein if the number of wireless devices exceeds a predetermined threshold, the communication characteristics corresponding to at least one of the wireless devices can be changed in order to cause a transfer of the wireless device to another gateway.
